(19) United States
(12) Patent Application Publication
(10) Pub. No.: US 2003/0029941 A1
(43) Pub. Date: Feb. 13, 2003

(54) Fuel injection and method for operating a fuel injection valve

(76) Inventor: Norbert Keim, Loechgau (DE)

Correspondence Address: KENYON & KENYON, ONE BROADWAY, NEW YORK, NY, 10004, US

(21) Appl. No.: 10/110,248

(22) PCT Filed: Aug. 8, 2001
(86) PCT No.: PCT/DE01/03026

(30) Foreign Application Priority Data
Aug. 10, 2000 (DE) 10039080.3

(51) Int. Cl. B05B 1/30; F02M 51/00

(52) U.S. Cl. 239/585.1; 239/585.3; 239/585.4; 239/585.5; 239/900

(57) ABSTRACT

A fuel injector (1), in particular for fuel injection systems of internal combustion engines, for direct injection of fuel into the combustion chamber of an internal combustion engine, has a solenoid (10), an armature (20), which is acted upon in a closing direction by a restoring spring (23), and a valve needle (3), which is linked in a force-locking manner to the armature (20), for actuating of a valve-closure member (4), which together with a valve-seat surface (6) forms a sealing seat. The armature (20) includes a first armature part (20a) and a second armature part (20b), the restoring spring (23) being supported on the first armature part (20a) and the second armature part (20b) being linked in a force-locked manner to the valve needle (3). The valve needle (3) is acted upon in the closing direction by the restoring spring (23) via the first armature part (20a) and the second armature part (20b) so that the valve-closure member (4) is held in a sealing position on the valve-seat surface (6).

### BACKGROUND INFORMATION

The present invention relates to a fuel injector according to the preamble of claim 1 and a method of operating a fuel injector according to the preamble of claim 7.

German Patent Application 33 14 899 A1 has already described an electromagnetically operable fuel injector in which an armature cooperates with an electrically energizable solenoid for electromagnetic operation, and the lift of the armature is transmitted via a valve needle to a valve-closure member. The valve-closure member cooperates with a valve-seat surface to form a sealing seat. The armature is not rigidly attached to the valve needle, but instead is situated on it so it is axially movable. A first restoring spring acts upon the valve needle in the closing direction and thus keeps the fuel injector closed when the solenoid is currentless and not energized. The armature is acted upon by a second restoring spring in the direction of lift so that in the resting position the armature is in contact with a first stop provided on the valve needle. On energization of the solenoid, the armature is moved in the direction of lift and entrains the valve needle beyond the first stop. When the current energizing the solenoid is switched off, the valve needle is accelerated into its closed position by the first restoring spring and entrains the armature past the stop described above. As soon as the valve-closure member strikes the valve seat, the closing movement of the valve needle is terminated abruptly. The movement of the armature that is not rigidly connected to the valve needle is continued in the direction opposite the direction of lift and is absorbed by the second restoring spring, i.e., the armature swings back against the second restoring spring which has a much lower spring constant than the first restoring spring. The second restoring spring finally accelerates the armature again in the direction of lift.

When the armature strikes the stop on the valve needle, it may result in a renewed brief lifting of the valve-closure member connected to the valve needle from the valve seat and thus to brief opening of the fuel injector. Debouncing in the fuel injector known from German Patent Application 33 14 899 A1 is therefore incomplete. Furthermore, a disadvantage of the conventional fuel injector in which the armature is rigidly connected to the valve needle, as well as with the fuel injector known from German Patent Application 33 14 899 A1 is that the opening lift of the valve needle begins immediately as soon as the magnetic force exerted by the solenoid on the armature exceeds the sum of the forces acting in the closing direction, i.e., the spring closing force exerted by the first restoring spring plus the hydraulic forces of the fuel under pressure. This is a disadvantage inasmuch when the current energizing the solenoid is turned on, the magnetic force has not yet reached its final value because of the self-induction of the solenoid and the resulting eddy currents. The valve needle and the valve-closure member are therefore accelerated by a reduced force at the beginning of the opening lift. This results in an opening time which is not satisfactory for all applications.

In the closing movement, the known one-part armature adheres to the magnetized internal pole for a relatively long time and is released only after a relatively long time due to the residual magnetization. This results in relatively long closing times.

### ADVANTAGES OF THE INVENTION

The fuel injector according to the present invention having the features of claim 1 and the method according to the present invention for operating a fuel injector having the features of claim 7 have the advantage over the related art that the opening and closing times of the fuel injector achieved by the two-part armature are reduced, which results in a greater accuracy in metering the fuel.

Advantageous refinements of the fuel injector characterized in claim 1 and the method characterized in claim 7 are possible through the measures characterized in the subclaims.

It is advantageous in particular that the restoring spring is supported directly on the first armature part and the valve needle is welded to the second armature part, because this design is simple and inexpensive to manufacture.

It is also advantageous that the two adjacent sides of the first and second armature parts are slightly wedge-shaped, thus preventing hydraulic adhesion and further accelerating the opening operation.

Through suitably dimensioned fuel channels in the two armature parts, an unhindered flow of fuel to the sealing seat is guaranteed and a slight hydraulic back-pressure may develop over the armature parts; this does not have a significant influence on the opening movement but it does support the closing movement.

Premagnetization of the solenoid and the first armature part is preferably initiated during the exhaust cycle of the internal combustion engine, during which the combustion chamber pressure drops on the one hand while on the other hand enough time is available to prepare for the next injection operation.

### DRAWING

An embodiment of the present invention is illustrated in simplified form in the drawing and explained in greater detail in the following description.

FIG. 1 shows a longitudinal schematic diagram through one embodiment of a fuel injector according to the present invention.

### DESCRIPTION OF THE EXEMPLARY EMBODIMENT

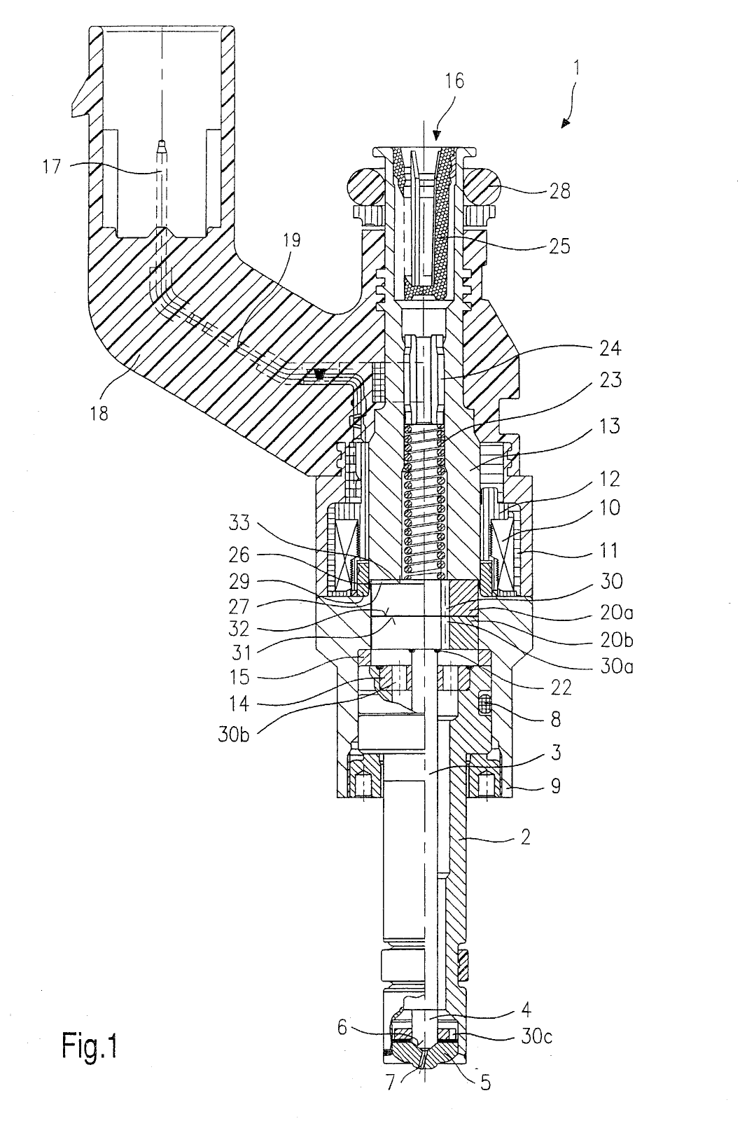

FIG. 1 shows a sectional diagram of an embodiment of a fuel injector 1 according to the present invention for implementing the method according to the present invention for direct injection of fuel.

Fuel injector 1 is designed in the form of a fuel injector for fuel injection systems of internal combustion engines having compression of a fuel mixture with spark ignition. Fuel injector 1 is suitable in particular for direct injection of fuel into a combustion chamber of an internal combustion engine (not shown).

Fuel injector 1 has a nozzle body 2 in which a valve needle 3 is situated. Valve needle 3 is mechanically linked to a valve-closure member 4 which cooperates with a valve-seat surface 6 situated on a valve seat body 4 to form a sealing seat. Fuel injector 1 in this embodiment is an inwardly opening fuel injector 1 having an injection orifice 7. Nozzle body 2 is sealed by a gasket 8 against stationary pole 9 of a solenoid 10. Solenoid 10 is encapsulated in a coil housing 11 and is wound onto a field spool 12 which rests on an internal pole 13 of solenoid 10. Internal pole 13 and stationary pole 9 are separated by a gap 26 and are supported on a connecting component 29. Solenoid 10 is energized by an electric current supplied via an electric plug-in contact 17 via a line 19. Plug-in contact 17 is encased in a plastic sheathing 18, which may be integrally molded on internal pole 13.

Valve needle 3 is guided in a valve needle guide 14 which is designed as a disk. A matching adjusting disk 15 is used to adjust the lift.

A two-part armature 20 is situated on the other side of adjusting disk 15. It is divided into a first armature part 20a and a second armature part 20b. Second armature part 20b is connected to valve needle 3 in a frictionally engaged manner via a weld 22. A restoring spring 23, being pre-tensioned by a sleeve 24 in the present design of fuel injector 1, is supported on first armature part 20a.

Fuel channels 30a through 30c, which carry fuel that is supplied via a central fuel feed 16 and is filtered through a filter element 25, to injection orifice 7, run in valve needle guide 14, in armature parts 20a and 20b and on valve seat body 5. Fuel injector 1 is sealed from a fuel distributor line (not shown) by a gasket 28.

In the resting state of fuel injector 1, first armature part 20a is acted upon by restoring spring 23 against its direction of lift, so that it rests on second armature part 20b and thus acts on valve needle 3 so that valve-closure member 4 is held on valve seat 6 in a sealing position. When solenoid 10 is energized, a magnetic field is built up from the inside to the outside, moving first armature part 20a in the direction of lift against the spring force of restoring spring 23, the lift being predetermined by a working gap 27 between internal pole 13 and first armature part 20a in the resting position.

In this phase of premagnetization, fuel injector 1 still remains closed because the pressure of the fuel flowing through fuel injector 1 on an inlet side 32 of second armature part 20b is still sufficiently high to press valve needle 3 into the sealing seat and thus keep fuel injector 1 closed. The premagnetization phase is advantageously already initiated during the exhaust cycle of the internal combustion engine, because in this phase, no high pressure prevails in the combustion chamber, and therefore fuel injector 1 remains closed due to the back-pressure of the fuel, even when first armature part 20a has already been picked up.

The radial symmetric wedge shape of inlet side 32 of second armature part 20b, as well as an injection side 31 of first armature part 20a guarantees that second armature part 20b will not adhere hydraulically on first armature part 20a and thus be picked up prematurely in the direction of lift.

In the second stage of the opening phase during which pressure is built up in the combustion chamber again, solenoid 10 is energized with a higher current, so that the magnetic field also expands in second armature part 20b and pulls it in the direction of lift toward first armature part 20a, against the hydraulic closing force which acts on inlet end face 32 of second armature part 20b. Therefore, valve needle 3, which is welded to second armature part 20b is also entrained in the direction of lift, so that valve-closure member 4 is lifted up from valve-seat surface 6, and the fuel carried to injection orifice 7 via fuel channels 30a through 30c is injected through injection orifice 7.

The movement of valve needle 3 may take place very rapidly in this phase of opening, because only second armature part 20b is accelerated, and in addition, only the hydraulic closing force need be overcome.

When the current energizing solenoid 10 is switched off, after the magnetic field has subsided sufficiently, first armature part 20a drops away from internal pole 13 due to the force of restoring spring 23 and the hydraulic closing force which acts in the same direction, so that second armature part 20b and valve needle 3 are also moved against the direction of lift. Therefore, valve-closure member 4 sits on valve-seat surface 6 and fuel injector 1 is closed.

If fuel injector 1 is closed again after the injection operation, the sum of the elastic force of restoring spring 23 and the hydraulic back-pressure of fuel during the compression and combustion cycles of internal combustion engine 1 is again high enough to seal fuel injector 1 against the combustion chamber pressure. During the exhaust cycle, in which the combustion chamber pressure drops, it is possible to begin again with premagnetization in preparation for the next injection operation without the longer premagnetization having a negative effect on the opening time of fuel injector 1.

The present invention is not limited to the embodiment presented here and is also suitable for outwardly opening fuel injectors, for example.

What is claimed is:

1. A fuel injector (1) for fuel injection systems of internal combustion engines, in particular for direct injection of fuel into the combustion chamber of an internal combustion engine, having a solenoid (10), an armature (20), which is acted upon in a closing direction by a restoring spring (23), and a valve needle (3), which is linked in a force-locked manner to the armature (20), for actuating of a valve-closure member (4), which together with a valve-seat surface (6) forms a sealing seat,
wherein the armature (20) has a first armature part (20a) and a second armature part (20b), which is axially movable with respect to the first armature part (20a), the restoring spring (23) being supported on the first armature part (20a), and the second armature part (20b) being linked in a force-locked manner to the valve needle (3), and
the valve needle (3) is acted upon in the closing direction by the restoring spring (23) via the first armature part (20a) and the second armature part (20b) so that the valve-closure member (4) is held in a sealing position on the valve-seat surface (6) when the solenoid (10) is not energized.

2. The fuel injector according to claim 1,
wherein the restoring spring (23) is supported on an inlet side (32) of the first armature part (20a).

3. The fuel injector according to claim 1 or 2,
wherein the valve needle (3) is fixedly connected to the second armature part (20b).

4. The fuel injector according to one of claims 1 through 3, wherein an injection side (31) of the first armature part (20a) rests on a inlet side (32) of the second armature part (20b).

5. The fuel injector according to claim 4,
wherein the injection side (31) of the first armature part (20a) and the inlet side (32) of the second armature part (20b) each have a wedge-shaped surface having radial symmetry.

6. The fuel injector according to one of claims 1 through 5, wherein the first armature part (20a) and the second armature part (20b) each have at least one fuel channel (30, 30a).

7. A method of operating a fuel injector (1) for fuel injection systems of internal combustion engines, in particular for direct injection of fuel into the combustion chamber of an internal combustion engine, having a solenoid (10), an armature (20), which is acted upon in a closing direction, and a valve needle (3), which is linked in a force-locked manner to the armature (20) for actuating of a valve-closure member (4), which together with a valve-seat surface (6) forms a sealing seat, the armature (20) having a first armature part (20a) and a second armature part (20b), a restoring spring (23) being supported on the first armature part (20a), and the second armature part (20b) being linked in a force-locked manner to the valve needle (3), and the valve needle (3) being acted upon in the closing direction by the restoring spring (23) via the first armature part (20a) and the second armature part (20b) so that the valve-closure member (4) is held in a sealing position on the valve-seat surface (6),
wherein the method includes the following steps:
energizing the solenoid (10) using an electric current having a first amperage, so that only the first armature part (20a) is pulled up, and then
energizing the solenoid (10) using a second amperage which is greater than the first amperage, so that the second armature part (20b) is also pulled up, and subsequently
switching off the current energizing the solenoid (10).

8. The method according to claim 7,
wherein energization using the first amperage is performed during an exhaust stroke of the internal combustion engine.
